(19) United States
(12) Patent Application Publication
(10) Pub. No.: US 2005/0151916 A1
(43) Pub. Date: Jul. 14, 2005

(54) Liquid crystal display

(76) Inventor: Masafumi Hoshino, Chiba-shi (JP)

Correspondence Address: BRUCE L. ADAMS, ESQ., 31ST FLOOR, 50 BROADWAY, NEW YORK, NY, 10004, US

(21) Appl. No.: 11/031,360

(22) Filed: Jan. 7, 2005

(30) Foreign Application Priority Data
Jan. 9, 2004 (JP) 2004-003674

(51) Int. Cl. G02F 1/1343

(52) U.S. Cl. 349/142

(57) ABSTRACT

A plurality of first layer wirings (15) and a plurality of second layer segment electrodes (20 and 21) are insulated by a plurality of color filters (16) and a smoothing film (18). A plurality of through-holes are formed in portions of a plurality of black matrices by patterning and then a plurality of second layer electrodes are formed, thereby connecting the plurality of first layer wirings to the plurality of second layer segment electrodes.

### BACKGROUND OF THE INVENTION

1. Field of the Invention

The present invention relates to a structure of a passive matrix color liquid crystal display using super-twisted nematic (referred to as STN) liquid crystal etc., and more particularly, to a structure of a liquid crystal display whose display area is driven to have two or more divided screens.

2. Description of the Related Art

A passive matrix liquid crystal display has a liquid crystal layer interposed between a common electrode substrate and a segment electrode substrate and pixels arranged in matrix. Examples of a driving method for a passive matrix type liquid crystal display include a voltage averaging method, smart addressing (SA) method, and multi line addressing (MLA) method.

Whichever driving method is used, increase of the number of common lines in a display area results in decrease of the ON/OFF ratio of the effective value of the driving voltage to be applied to the liquid crystal, thus reduction of contrast as well as slowing of response speed occurs. A method of solving such a problem involves: dividing the display area of the liquid crystal display into two or more screens; and driving each of the screens by the number of commons divided to increase the ON/OFF ratio of the effective value. As a result, a panel having high contrast as well as high speed of response can be obtained.

A configuration of the liquid crystal display which is divided horizontally into two or more screens can be achieved by laminating at least two wiring/electrode layers comprising the first layer wirings and the second layer electrodes which are electrically isolated by an insulation film.

FIG. 2 is a cross-sectional view showing a typical configuration of a semi-transparent passive matrix color liquid crystal display which adopts no multi-divided screen driving.

Aluminum having a thickness of about 0.15 μm is first deposited by sputtering on a glass substrate 11 to which color filter is formed later, and then reflecting plates 25 are formed by patterning of the aluminum film. After that, acrylic resin in which pigment is dispersed is applied on the reflecting plates 25 by spinner, and then patterned. This process is repeated to form color filters 16 and black matrices 17. Acrylic resin is then applied on the color filters 16 and the black matrices 17 by spinner to form a smoothing film 18. Next, transparent electrodes for driving liquid crystal are formed by patterning a film of indium tin oxide (referred to as ITO) etc. deposited by sputtering (see JP05-323338A, for example) Driving a passive matrix in a conventional liquid crystal display configuration, the number of scanning electrodes is limited up to approximately 200 to 480 to maintain display quality. With increasing number of the scanning electrodes, contrast and a viewing angle become narrowed. In this structure the maximum number of the divided screens which can be driven is two. The aforementioned laminated wiring/electrode configuration is required to drive two or more divided screens. In this configuration however there arises a problem of increase in manufacturing process coming from the fact that additional film formation and patterning are required for each wiring, electrode, and insulation film all of which are laminated. Another problem in the aforementioned configuration is that the second layer electrode is formed on the first layer wiring, and thus a large parasitic capacitance is generated between the first layer wiring and the second layer electrode, consequently electric power consumption increases. There arises a further problem in that signals applied to the first layer wiring and the second layer electrode are influenced with each other by the parasitic capacitance to distort waveforms, thereby giving different luminosity to each divided screen and degrading display quality.

### SUMMARY OF THE INVENTION

The present invention has been made to solve the aforementioned problems, and an object of the present invention is to provide a liquid crystal display in which a segment electrode substrate has two-layer configuration in which the first layer wirings and the second layer electrodes are insulated by color filters and a smoothing film when the segment electrodes are divided to drive multi-divided screens. The first layer wirings to the second layer electrodes are connected by through-holes which are formed in portions of black matrices by patterning before the second layer electrodes are formed.

Further, the first layer wiring is made from a metal thin film such as aluminum so that parasitic capacitance is reduced since fine but low-resistance wiring can be made. Furthermore, low electric power consumption and high display quality are achieved since no portion of the first layer wiring other than the through-holes is overlapped with the second layer electrode.

In the configuration of the liquid crystal display according to the present invention, addition of only one process to a typical color filter manufacturing process enables a double-layer configuration in which the segment electrodes are divided into first-layer wirings and second-layer electrodes, and the panel can be driven divisionally at low duty. Accordingly, in comparison to the method of laminating the wiring electrode and the insulation film by the conventional divisional driving, a low-cost panel can be manufactured, and a liquid crystal display with improved display quality and reduced power consumption can be provided in comparison to a panel with high duty driving of an ordinary single layer electrode having the same number of pixels.

### BRIEF DESCRIPTION OF THE DRAWINGS

In the accompanying drawings:

FIG. 1 is a cross-sectional view showing a panel of a transparent liquid crystal display of the present invention;

FIG. 2 is a cross-sectional view showing a panel of a conventional semi-transparent liquid crystal display;

FIG. 3 is a top View showing a segment electrode substrate of the transparent liquid crystal display of the present invention;

FIG. 4 is a top view showing a segment electrode substrate of a semi-transparent liquid crystal display of the present invention; and

FIG. 5 is a drawing showing an example of the liquid crystal display of the present invention.

### DETAILED DESCRIPTION OF THE PREFERRED EMBODIMENTS

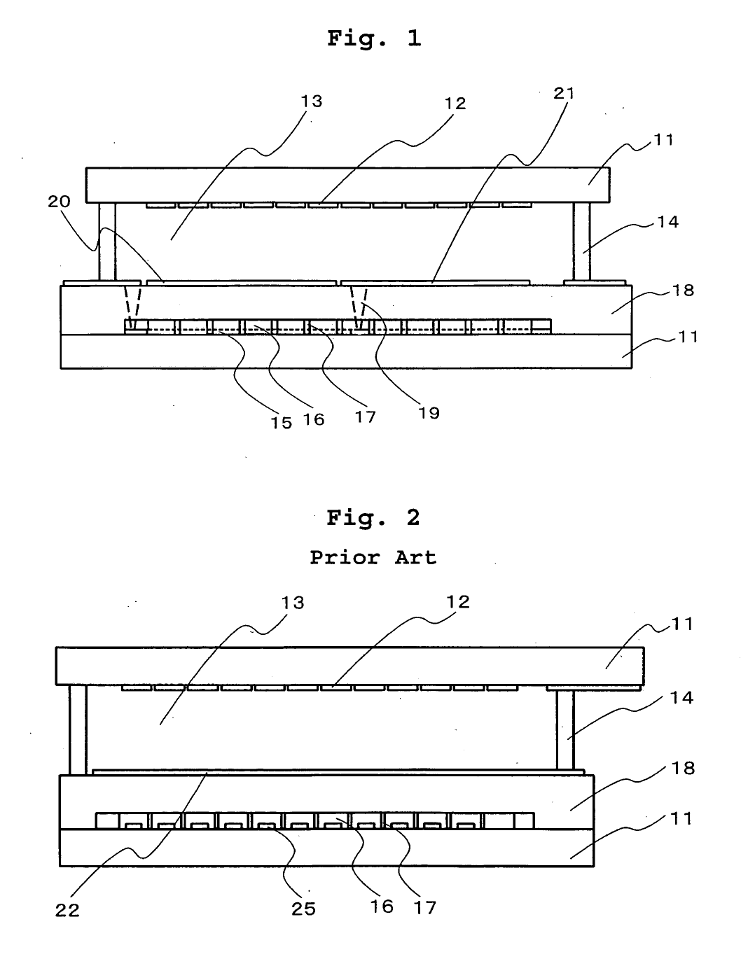

FIG. 5 shows an example of a liquid crystal display of the present invention, in which one liquid crystal panel is driven divisionally in the first screen 53 and in the second screen 54. FIG. 1 is a cross-sectional view showing the transparent liquid crystal display of the present invention, taken from the FIG. 5 along the line A-A′ of the panel 53 and 54.

At first aluminum is deposited by sputtering on a glass substrate 11 to which color filters are formed later and then the first layer wirings 15 are formed by patterning. When the aluminum thin film on pixel portions are left at this time as reflecting plates electrically separated from wiring electrodes, a semi-transparent liquid crystal panel will be made. Acrylic resin dispersed with pigment is applied on the reflecting plates by spinner, and then patterned. This process is repeated to form color filters 16 and black matrices 17. Acrylic resin is further applied on the color filters 16 and the black matrices 17 by spinner to form a smoothing film 18. Next, through-holes 19 are made in the black matrices 17 and in the smoothing film 18 by patterning. Finally, a film of ITO etc. is deposited by sputtering and then patterned to form the first segment electrodes 20 and the second segment electrodes 21.

In this embodiment, a film thickness is set to 0.15 μm for aluminum, 0.5 μm for the color filter and the black matrix, and 1.0 μm for the smoothing film. A thick film thickness is preferable for reducing electric power consumption though making of through-holes becomes difficult.

As described above, only addition of the process of forming through-holes to a typical color filter manufacturing process enables the segment electrodes to be driven divisionally to have multi-screen display, and realizes a liquid crystal display with good display quality easily.

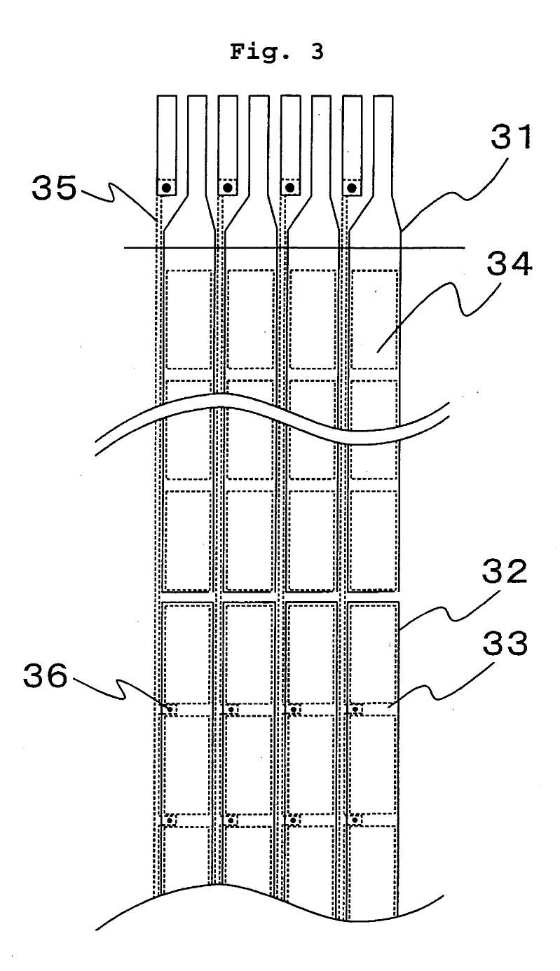

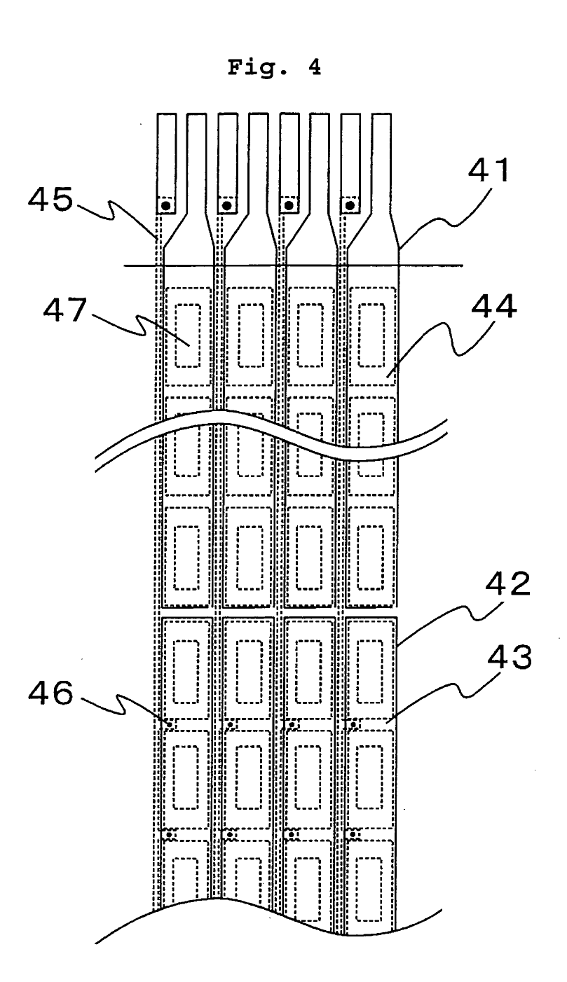

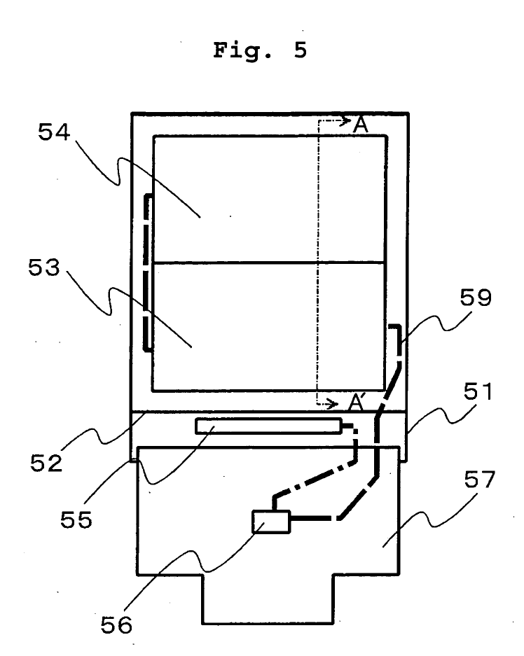

FIG. 3 is a top view showing a segment electrode substrate of the transparent liquid crystal display of the present invention, and FIG. 4 is a top view showing a segment electrode substrate of the semi-transparent liquid crystal display of the present invention.

In the embodiment of a segment electrode substrate of the transparent liquid crystal display as shown in FIG. 3, a plurality of second segment electrodes 32 are arranged so that a plurality of first layer wirings 35 for connecting to terminal electrodes are not overlapped with a plurality of first segment electrodes 31. However, if the wiring electrodes are sufficiently fine and the film thicknesses of the color filters and a smoothing film are thick enough, the first layer wirings 35 may be disposed beneath the second layer electrodes 31.

Further, in the embodiment of a segment electrode substrate of the semi-transparent liquid crystal display as shown in FIG. 4, a plurality of reflecting plates 47 and a plurality of second layer electrodes 45 are simultaneously formed. The plurality of reflecting plates 47 are electrically isolated from the plurality of second layer electrodes 45 to prevent the generation of a parasitic capacitance with respect to a plurality of first layer wirings 41.

1. A liquid crystal display, comprising: a common electrode substrate; a segment electrode substrate opposed to the common electrode substrate; a liquid crystal layer interposed between the common electrode substrate and the segment electrode substrate; a plurality of common electrodes provided on the common electrode substrate; and a plurality of segment electrodes provided on the segment electrode substrate, the plurality of segment electrodes being formed in two layers to drive multi-divisionally,
wherein a plurality of first layer wirings and a plurality of second layer segment electrodes are insulated by a plurality of color filters and a smoothing film.

2. A liquid crystal display according to claim 1, wherein each of the plurality of first layer wirings is formed by a metal film.

3. A liquid crystal display according to claim 1, wherein the plurality of first layer wirings and a plurality of reflecting plates are simultaneously formed.

4. A liquid crystal display according to claim 1, wherein the plurality of first layer wirings and the plurality of reflecting plates are electrically isolated.

5. A liquid crystal display according to claim 1, wherein the plurality of first layer wirings overlaps with the plurality of second layer segment electrodes only at through-holes.

6. A liquid crystal display according to claim 1, wherein the plurality of first layer wirings and the plurality of second layer segment electrodes are electrically connected by a plurality of through-holes provided in a plurality of black matrices.
